(19) United States
(12) Patent Application Publication
(10) Pub. No.: US 2024/0144763 A1
(43) Pub. Date: May 2, 2024

(54) METHOD FOR VALIDATING ACCESS, BY A USER, TO AN ACCESS ZONE AND ASSOCIATED ELECTRONIC VALIDATION SYSTEM

(71) Applicant: Revenue Collection Systems France SAS, Le Plessis-Pâté (FR)

(72) Inventors: Michel DANCYGIER, Bretigny Sur Orge Cedex (FR); Julien MARTIN, Bretigny Sur Orge Cedex (FR)

(21) Appl. No.: 18/548,000

(22) PCT Filed: Feb. 24, 2022
(86) PCT No.: PCT/EP2022/054607

§ 371 Date: Aug. 25, 2023

(30) Foreign Application Priority Data
Feb. 25, 2021 (FR) FR2101844

(51) Int. Cl. G07C 9/27; H04W 12/64

(52) U.S. Cl. CPC G07C 9/27; H04W 12/64

(57) ABSTRACT

Method for validating access, by a user, to an access zone and associated electronic validation system

The invention relates to a method for validating an access, for a user (10), to an access zone (Z₅) of a public transport vehicle (5). The method is implemented by an electronic generation system (15),

The method comprises the following successive steps:
reception of a request for access (Da) to the access zone, from the connected device (20) in an approval zone,
pre-validation of the request for access if the request meets a predetermined condition, and
determination of a location of the connected device in the access zone (Z₅) distinct from the approval zone.

The method further comprising, once the location of the connected device has been determined in the access zone and only if the request for access is pre-validated, a validation step for an access to the access zone for the user, by decrementing an account specific to the user.

The present invention relates to a method for validating an access, for a user, to an access zone, the access zone giving access to a public transport vehicle, the method being of the type comprising the following successive steps:
reception of a request for access to the access zone, from the connected device in an approval zone,
pre-validation of the request for access if the request meets a predetermined condition, and
determination of a location of the connected device in the access zone separate from the approval zone.

WO 2020/193568 A1 describes such an access validation method.

The method comprises a first step of sending an accreditation, from an electronic device of a user to a validation system, according to a Bluetooth protocol. The method further comprises editing and sending a secret parameter to the user's electronic device, according to the Bluetooth protocol, upon reception of the accreditation. Finally, the method comprises locating the user's electronic device via a second communication mode, using an Ultra-Wide Band.

Once the user is located close to the door, and in possession of the secret parameter initially issued according to the Bluetooth protocol, the access is unlocked by recognition of the secret parameter.

However, such method cannot be used for taking into account a user who would finally change their mind about accessing the access zone. Indeed, with such a method, an access validation is performed when the user is close to the door.

The goal of the invention is thus to propose a method for validating an access apt to consider a user changing their mind at the last moment about accessing the access zone.

To this end, the subject matter of invention is a method for validating an access of the aforementioned type, the method comprising, once the location of the connected device has been determined in the access zone and only if the request for access is pre-validated, a validation step for the access to the access zone for the user, by decrementing an account specific to the user.

According to particular embodiments, the method comprises one or more of the following features, taken individually or according to all technically possible combinations:
the method comprises, between the pre-validation step and the determination step, a step of sending a proof of pre-validation to the connected device,
during the determination step, the location of the connected device is determined from at least one location signal including the proof of pre-validation, the at least one location signal being received from the electronic device,
during the reception step, the request for access is received in an extended wireless communication mode,
during the pre-validation step, a proof of pre-validation is generated in response to a comparison of the request for access to a database of rights to travel,
an initialization step during which an initialization signal for the procedure is sent to the connected device in the approval zone, using a wireless home communication mode, the determination step being performed on the basis of at least one signal exchanged according to a location wireless communication mode,
the reception and the location wireless communication modes being distinct,
the reception and location wireless communication modes each following a LAN protocol.

A further subject matter of the invention is an electronic system for validating an access for a user, to an access zone to a public transport vehicle, the electronic validation system comprising:
a remote server comprising a set of module(s) configured for receiving a request for access to the access zone, from the connected device in an approval zone, and to pre-validate the request for access if the request satisfies a predetermined condition,
at least one location transceiver apt to receive a location signal from the connected device in the access zone distinct from the approval zone, and
a local server connected to the at least one location transceiver and to the remote server, the local server comprising a calculation module apt to determine the location of the connected device,
characterized in that the set of module(s) is also configured, once the location of the connected device is determined to be in the access zone and only if the request for access is pre-validated, for validating an access to the access zone for the user, by decrementing an account specific to the user.

According to a particular embodiment, the electronic validation system comprises one or a plurality of the following features, taken individually or in all technically possible combinations:
the access zone is located inside the public transport vehicle,
the access zone is located between at least one security portal and the public transport vehicle,
the calculation module is further configured for issuing an instruction to open the or one of the security gates following the determination of the location of the connected device in a entry zone and only if the request for access to the access zone has been pre-validated.

Such features and advantages of the invention will become clearer upon reading the following description, given only as a non-limiting example, and made with reference to the enclosed drawings, wherein;

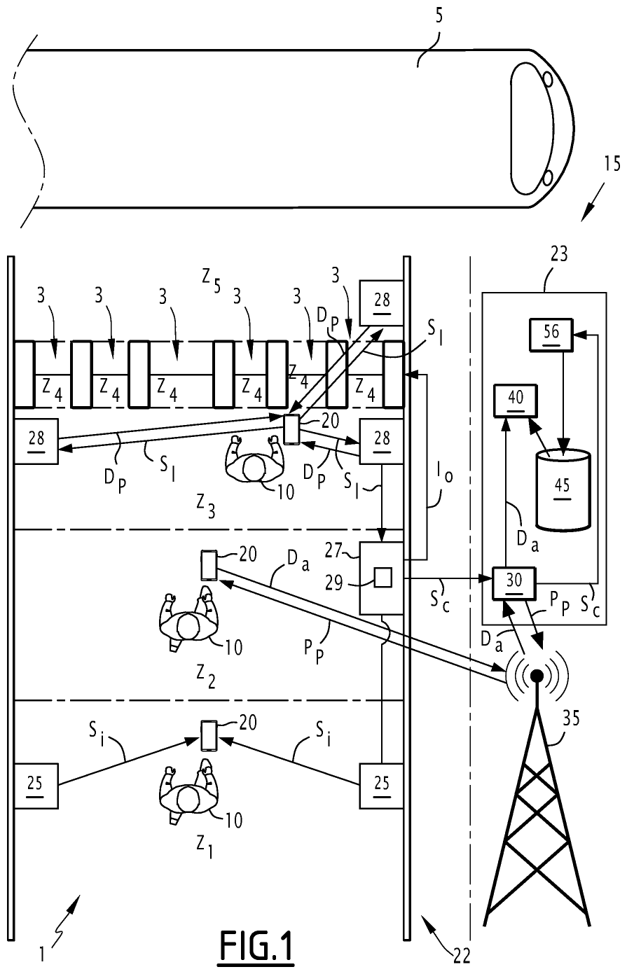

FIG. 1 is a partial schematic representation of an access hall of a subway station comprising an electronic system for validating an access according to the invention;

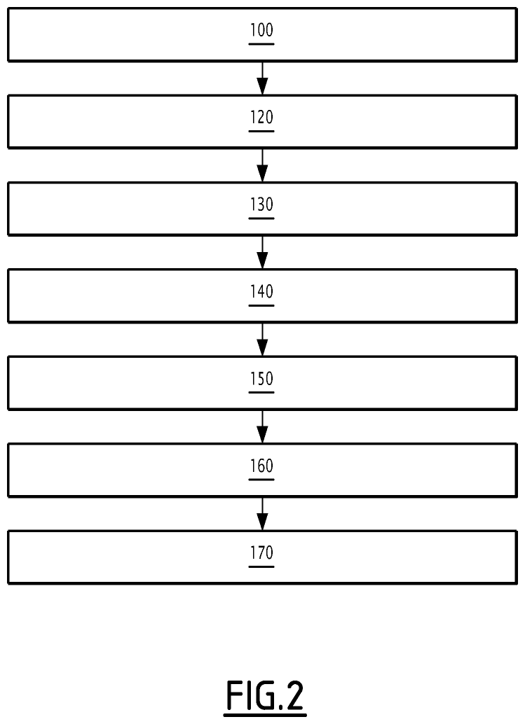

FIG. 2 is a flowchart of a method for validating an access according to the invention, the method being implemented by the electronic validation system shown in FIG. 1;

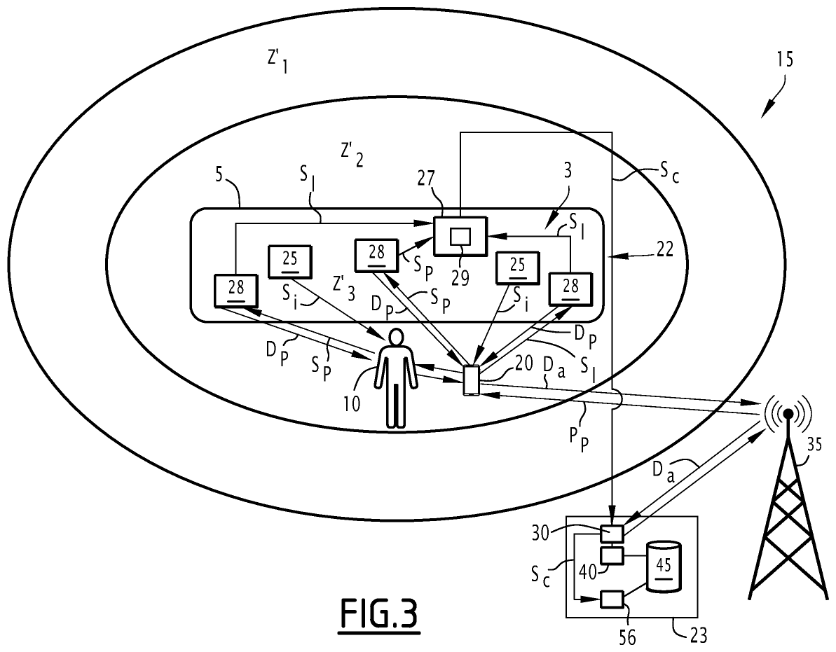

FIG. 3 is a partial representation of an environment around a public transport vehicle, another embodiment of the electronic validation system being applied to an access zone comprised in the public transport vehicle; and

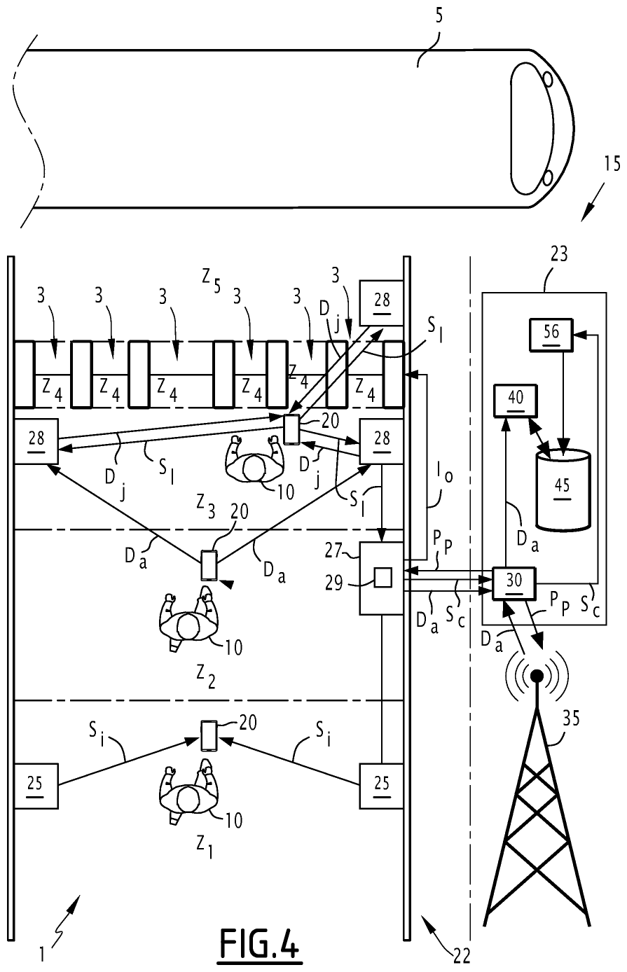

FIG. 4 is a partial schematic representation of the hall of shown in FIG. 1 comprising an electronic system for validating an access according to a variant of embodiment.

According to a first embodiment, and as partially visible in FIG. 1, an access hall 1, e.g. of a subway station, comprises security gates 3 limiting the access to a public transport vehicle 5 to users 10 whose access is validated. Hall 1 is fictitiously divided into a plurality of successive zones, called approach zone Z₁, approval zone Z₂, location zone Z₃, entry zone Z₄, and access zone Z₅, respectively. Each of the zones will be described in greater detail hereinafter.

Each gate 3 is located in the entry zone Z₄ and delimits the entry zone Z₄ from the access zone Z₅. Each gate comprises a door apt to open in order to allow the user 10 to pass through following the reception of an opening instruction from an electronic validation system 15.

The user 10 has a connected device 20 apt to communicate with other electronic devices according to three wireless communication modes. The connected device 20 is e.g. a smartphone, a connected watch, a connected bracelet, or a connected necklace.

The electronic validation system 15 comprises an equipment installation 22 integrated into the hall 1 and a remote server 23.

The remote server 23 is more than one kilometer away from the installation 22.

The equipment installation 22 and the remote server 23 are connected. Herein and hereinafter in the description, the terminology “connected” refers both to a wired connection and to a wireless connection. Thereby, two elements are called connected if the elements are apt to exchange data.

The validation system 15 is configured for validating an access, for the user 10, to the access zone Z₅. The access zone Z₅ is e.g. a subway platform or a corridor leading to the platform. Thereby, the access zone Z₅ is located between the gates 3 and the vehicle 5.

The installation 22 comprises two reception transceivers 25 attached on walls of the hall 1 and opposite the approach zone Z1. The reception transceivers 25 are wireless communication terminals following a reception wireless communication mode. The wireless reception communication mode follows a Local Area Network (LAN) protocol. More particularly, each reception transceiver 25 follows the low-power Bluetooth Low Energy (BLE) protocol. Herein, the term LAN protocol refers to a wireless communication protocol the range of which does not exceed a hundred meters, as defined e.g. in the Bluetooth standard.

The reception transceivers 25 are suitable for issuing a signal for initializing the procedure Si towards the connected device or devices 20 present in the approach zone Z₁ and in the approval zone Z₂, according to the first communication mode. The initialization signal of the procedure Si is intended to wake up a ticketing application on the or each connected device 20 and to activate a function for sending a request for access Da from said application. The waking up as defined herein, refers to a launching of an application on the connected device 20, at least as a background task.

Furthermore, each reception transceiver 25 is connected to a local server 27 integrated into the installation 22.

The local server 27 is e.g. a terminal attached to one of the walls of the hall 1, or integrated into one of the walls of the hall 1. The local server 27 comprises a processor and a memory (not shown). The memory thereof is suitable for storing software modules comprising instructions suitable for being executed by the processor. The local server 27 is connected to each piece of equipment of the installation 22, to the remote server 23 and to the gates 3.

The installation 22 further comprises at least three location transceivers 28. Each location transmitter-receiver 28 is a communication terminal attached to a wall or to the ceiling of the hall 1, opposite the location zone Z₃ and connected to the local server 27.

Each location transceiver 28 is configured for sending a request Dp, to the connected device 20, for a proof of pre-validation Pp, according to a wireless location communication mode. The wireless location communication mode follows a LAN protocol. The LAN protocol followed by location communication mode is an Ultra-Wide Band (UWB) communication mode. Such a communication mode is characterized by a wide transmission and reception frequency band, preferentially with a width greater than 500 MHZ. The frequency band is located between 3.1 GHZ and 10.6 GHz. For example, the transmission frequency band of the ninth UWB channel is comprised between 7392 MHz and 7920 MHz. The UWB communication mode is also characterized by a substantially low signal amplitude, e.g. equal to −41.3 dBm/MHz.

Each location transceiver 28 is also configured for receiving from the connected device 20, the proof of pre-validation Pp, according to the location communication mode. To this end, each location transmitter-receiver 28 is apt to regularly receive a location signal SI from the connected device 20, for as long as the connected device is in one of the location zone Z₃, the entry zone Z₄ or the access zone Z₅.

Each location signal SI comprises the proof of pre-validation Pp and e.g. a time of 15 transmission of the signal.

Each location transmitter-receiver 28 is also configured for sending the location signals received to the local server 27, by adding thereto a reception time of the signal by the location transmitter-receiver 28.

The server comprises a calculation module 29 in the form of software configured, 20 following the reception of the location signals from each of the location transceivers 28, for calculating and determining a location of the connected device 20 and hence of the user 10.

To this end, the calculation module 29 is configured for carrying out a trilateration or a multilateration of the received signals in order to determine the location of the connected device 20 from transmission and reception times.

It should be understood that such trilateration is possible only if at least three location transceivers 28 are present.

In a variant, the calculation module 29 is configured for determining the location of the connected device 20 by integrating a speed of the device 20. The speed of the device 20 is then determined from variations in the differences between the reception and transmission times.

The calculation module 29 is apt to determine the location of the device 20 in the location zone Z₃, the entry zone Z₄ and the access zone Z₅.

The calculation module 29 is further configured for determining, following a determination of the location of the connected device 20 in the location zone Z₃, towards which gate 3 the user 10 is heading. To this end, the calculation module 29 is e.g. apt to determine from the set of gate(s) 3 which is closest to the connected device 20.

The calculation module 29 is also configured for transmitting, following the determination of the gate 3 towards which the user 10 is heading and once the location of the connected device 20 has been determined in the entry zone Z₄, an opening instruction towards the gate 3 which has been determined.

Furthermore, the calculation module 29 is configured for sending to the remote server 23, if the location of the connected device 20 is determined in the access zone Z₅, a confirmation signal Sc of a passage of the user 10.

It is clear that such an action requires that the connected device 20 has received the proof of pre-validation Pp since a determination of the location is made on the basis of the location signals comprising the proof Pp.

The remote server 23 is common to a plurality of halls 1, as described hereinabove. The remote server 23 comprises a processor (not shown) and a memory (not shown). The memory is apt to store software also called software modules or software bricks. The remote server 23 communicates by wire with the equipment integrated in the hall 1, via the local server 27. The communication follows the Ethernet protocol.

The remote server 23 comprises an acquisition-sending software module 30 configured for receiving, from the connected device 20, a request for access Da to the access zone Z₅, via a relay antenna 35. For this purpose, the remote server 23 is e.g. connected to a relay antenna network by Ethernet connection.

The connected device 20 is apt to communicate with the relay antenna (35) in an extended wireless communication mode. The extended communication mode follows a Wide Area Network (WAN) protocol. Said protocol is advantageously a mobile network protocol for telephony, such as Edge, 3G, 4G, 5G or other more advanced mobile network technologies for telephony. WAN refers herein to mean a wide range communication protocol, i.e. a range greater than 1 km.

The acquisition-sending module 30 is also configured for sending the proof of pre-validation Pp of the request for access Da to the connected device 20, via the same relay antenna 35 or another relay antenna (not shown) which communicates the proof Pp according to the extended communication mode.

The acquisition-sending module 30 is then apt to perform the reception and the sending when the user 10 is in the approval zone Z₂.

The remote server 23 further comprises a processing module 40 in the form of software stored in the memory. The processing module 40 is apt, on the basis of the request for access Da received, to pre-validate the request for access Da and to generate the proof of pre-validation Pp.

To this end, the processing module 40 is configured for consulting a database 45, included in the memory of the remote server 23 and comprising information relating to the validity of the right(s) to travel of each registered user. A registered user refers herein to a user 10 having the ticketing application on his/her connected device 20 with a valid user account. A valid account refers herein to an active account registered in the ticketing application.

Thereby, the processing module 40 is configured for generating, if the user has a valid right to travel in the database 45, the proof of pre-validation Pp of the access to the access zone Z₅.

The right to travel is e.g. a ticket already purchased or a credit account for an amount greater than the price of one ticket.

The remote server 23 further comprises a validation software module 56 configured for validating, after receiving the confirmation signal Sc from the calculation module 29, the right to travel of the user 10 by decrementing an account of the user 10. To this end, the validation module 56 is suitable, if the right to travel is a transport ticket, for validating same digitally by communication with the database 45. Such validation makes the title unusable for a future trip.

As a variant or as an optional supplement, the validation module 56 is suitable, if the right to travel is a credit account for an amount greater than the price of one transport ticket, for debiting therefrom, in the database 45, an amount equal to the price of one transport ticket.

The operation of the electronic validation system 15 will now be described with reference to FIG. 2, showing a flowchart of a method implemented by the system 15.

The user 10 is in the approach zone Z₁ and moves towards the access zone Z₅, equipped with the connected device 20.

During an initialization step 100, the reception transceivers 25 transmit the initialization signal of the procedure Si towards the connected device 20. As the user 10 arrives in the approval zone Z₂, the user receives the procedure initialization signal Si, which has the effect of waking up the ticketing application and of activating the functionality of sending the request for access Da of said application.

During a reception step 120, the user 10 still being in the approval zone Z₂, the acquisition-sending module 30 of the remote server 23 receives the request for access Da from the connected device 20, via the relay antenna 35.

During a pre-validation step 130, the processing module 40 pre-validates the request for access Da by consulting the database 45, as described hereinabove. If the request for access Da satisfies the predetermined condition, i.e. if the request for access Da corresponds to a user having a transport ticket already purchased or a credit account for an amount greater than the price of one transport ticket, then the processing module 40 generates the proof of pre-validation Pp.

During a sending step 140, the acquisition-sending module 30 sends the proof of pre-validation Pp to the connected device 20, via the relay antenna 35, according to the extended communication mode.

During a step 150 of determining a location of the connected device 20, the user 10 reaching the location zone Z₃, the connected device 20 of the user 10 then receives the proof of pre-validation request Dp from the remote server 23, via the relay antenna 35. In response, the connected device 20 sends, towards each location transceiver 28, the location signal SI comprising the proof of pre-validation Pp and the time of transmission of the location signal SI, according to the location communication mode.

During the step 150, each location transmitter-receiver 28 transfers, to the local server 27, the location signal SI by adding thereto the time of reception of the signal by the location transmitter-receiver 28.

The calculation module 29 then determines the location of the connected device 20 from the location signals, as described hereinabove.

Still during the determination step 150, the calculation module 29 determines towards which gate 3 the user 10 is heading, from the location of the connected device 20.

Once the location of the user 10 has been determined to be in the entry zone Z₄, during a transmission step 160, the calculation module 29 transmits, towards the gate 3 which has been determined, the opening instruction lo.

Following this opening instruction lo, the door of the corresponding gate 3 opens, the user 10 crosses therethrough and reaches the access zone Z₅.

The system 15 then moves to a validation step 170, wherein the validation module 56 validates the right to travel of the user 10 by decrementing the account of the user 10.

A second embodiment will now be described with reference to FIG. 3 and only by the differences thereof from the first embodiment. Thereby, all the features described for the first embodiment and not described hereinbelow, should be considered as analogous to the first embodiment.

According to the second embodiment, the installation 22 is integrated into the public transport vehicle 5 instead of the hall 1. The vehicle 5 is e.g. a surface vehicle such as a bus, a tram, a coach or a boat. Thereby, the reception transceivers 25, the location transceivers 28 and the local server 27 are integrated into the vehicle 5. According to the second embodiment, the local server 27 is connected by a wireless link to the remote server 23.

The electronic validation system 15 then defines three concentric alternative zones, presented from the most eccentric of the vehicle 5 to the least eccentric of the vehicle 5, as follows: an alternative approach zone Z′₁, an alternative approval zone Z′₂, and an alternative access zone Z′3. The alternative access zone Z′₃ corresponds to the footprint zone of the vehicle 5, i.e. the surface occupied by the projection of the vehicle 5 onto the ground, or onto the water in the case of a boat.

It is notable that, unlike the first embodiment, the alternative zones Z′₁, Z′₂ and Z′₃ are mobile relative to the environment. Indeed, since the alternative zones Z′₁, Z′₂ and Z′₃ are defined with respect to the vehicle 5, same are subjected to a displacement consistent with the movement of the vehicle 5.

In the example shown in FIG. 3, the vehicle 5 is a bus operating in an urban environment, the alternative approach zone Z′₁ extends e.g. over the entire width of a street, i.e. including the roadway as well as the sidewalks on both sides of the roadway. In such example, the alternative approval zone Z′₂ extends over the entry lane on which the vehicle 5 moves and includes the nearest sidewalk. Finally, in such example, the alternative access zone Z′₃ is limited to the surface occupied by the vehicle 5 on the entry lane thereof.

Parallel to the first embodiment, in the second embodiment, the alternative approach zone Z′₁ corresponds to the approach zone Z₁ of the first embodiment. Furthermore, the alternative approval zone Z′₂ corresponds to the approval zone Z₂ of the first embodiment. In addition, the alternative access zone Z′₃ corresponds to the location zones Z₃, the entry zone Z₄ and the access zone Z₅ of the first embodiment.

More particularly, each reception transceiver 25, location transceiver 28, as well as each acquisition-sending module 30, processing module 40 and validation module 56 is configured for performing the same actions as in the first embodiment, but in the alternative approach zones Z′₁, approval Z′₂ and access Z′₃.

For this purpose, the reception transceivers 25 are attached to the internal or external walls of the vehicle 5. In the example shown in FIG. 3, the two reception transceivers 25 are e.g. at the front and at the rear, respectively of the vehicle 5 in order to detect and identify the connected device 20 in an alternative approval zone Z′₂ which is as large as possible.

Furthermore, the location transceivers 28 are attached to the internal walls of the vehicle 5. In the example shown in FIG. 3, the location transceivers 28 are as far apart as possible from each other, so as to maximize the differences in travel time of the location signals between the connected device 20 and each of the second transceivers 28, in order to lead to a better location of the connected device 20. In the example shown in FIG. 3, two of the three location transceivers 28 are attached in corners of the vehicle 5 sharing two common walls, the third location transceiver 28 being attached to a wall opposite at least one of the common walls.

Since the vehicle 5 does not have gates 3, the calculation module 29 is not configured for sending the opening instruction lo.

However, the calculation module 29 is configured for sending the confirmation signal Sc to the validation module 56 only if the connected device 20 has received the proof of pre-validation Pp and once the connected device 20 is no longer detected in the alternative access zone Z′₃. In other words, the calculation module 29 is configured for sending the confirmation signal Sc after the connected device 20 has been and is no longer located in the alternative access zone Z′₃. Indeed, the location of the connected device 20 is only possible if same has received the proof of pre-validation Pp since the location signal SI comprises the proof of pre-validation Pp.

In a variant, the validation system 15 is connected to another item of electronic equipment (not shown) of the vehicle 5. The local server 27 is configured for receiving a motion signal from the equipment when the vehicle 5 is in motion. In such variant, the calculation module 29 is configured for sending the confirmation signal Sc only if the connected device has received the proof of pre-validation Pp and following the determination of the location of the connected device 20 as being in the alternative access zone Z′₃ and upon reception of the signal of motion. Thereby, the validation module 56 is configured for validating the right to travel of the user 10, once the user 10 has entered the vehicle 5 and the vehicle 5 is in motion.

In operation, each of the initialization 100, reception 120, pre-validation 130, sending 140 and determination 150 steps is analogous to the first embodiment except when the user 10 is located in the alternative approach zone Z₁′, approval zone Z₂′ or access zone Z₃′ respectively, according to the correspondence explained hereinabove, with each of the zones Z₁, Z₂, Z₃, Z₄, Z₅, of the first embodiment.

However, in the second mode of operation, the method does not comprise a transmission step 160. Indeed, the calculation module 29 does not issue the opening instruction lo since there is no gate 3.

During the validation step 170, the validation module 56 validates the right to travel of the user 10 by validating the ticket or by debiting an amount equal to the price of a ticket, from the account of the user 10, when the determination of the location of the device 20 is no longer carried out, i.e. when the device 20 leaves the alternative access zone Z₃′. In other words, during the validation step 170, the validation module 56 validates the right to travel of the user 10 after the user has left the vehicle 5.

According to a variant of the two embodiments, represented in FIG. 4 in the example of the first embodiment, during a purchase of the ticket via the ticketing application, prior to the validation method, an identification token of the transport ticket is generated by the processing module 40 in connection with the database 45. Following the generation thereof, the token is sent by the remote server 23 to the device 20 via the ticketing application and is stored by the application in the device 20 until same is used.

Such variant is presented only by the differences from the first and second embodiments.

If the connected device 20 is unable to communicate with the remote server 23, e.g. because of the absence of a network, the location transceivers 28 are apt to receive the request for access Da comprising the token from the device 20. The reception is performed e.g. when the user is in the approval zone Z₂; Z′₂. The server 27 is then apt to transfer the token from the location transceivers 28 to the acquisition-sending module 30 of the remote server 23. The processing module 40 is then configured for pre-validating the request for access Da by verifying the validity of the token by consulting the database 45. As a result, the processing module 40 is apt to generate the proof of pre-validation Pp and to send same to the local server 27.

In such variant, no communication between the connected device 20 and the remote server 23 passes through the relay antenna 35.

Furthermore, the location transceivers 28 are configured for sending a request for a token Dj to the connected device 20 instead of a request Dp for the proof of pre-validation Pp.

Thereby, the device 20, in response to the proof of pre-validation request Pp, is apt to replace the proof of pre-validation Pp by the token in the location signal SI. The calculation module 29 is then configured for sending, where appropriate, the opening instruction lo to the gate 3 which has been determined, only if the local server 27 has received the proof of pre-validation Pp.

It is clear that the condition, presented in both embodiments, according to which: the proof of pre-validation Pp is received by the device 20, becomes in said variant, the proof of pre-validation Pp received by the local server 27.

The method according to the invention makes it possible, in each of the embodiments, to take into account whether the user 10 changes their mind about accessing the access zone Z₅; Z′₃. In such a situation, the method does not validate the access of the user 10 and hence does not decrement the account of the user 10.

Furthermore, by means of the proof of pre-validation Pp, the method according to the invention ensures that each user 10 accesses the access zone Z₅; Z′₃ if the user is authorized to do so.

1. A method for validating an access, for a user, to an access zone to a public transport vehicle, the method being implemented by an electronic validation system, the method comprising the following successive steps:
reception of a request for access to the access zone from a connected device, in an approval zone,
pre-validation of the request for access if the request satisfies a predetermined condition, and
determination of a location of the connected device in the access zone distinct from the approval zone,
wherein the method further comprises, once the location of the connected device has been determined in the access zone and only if the request for access is pre-validated, a validation step of an access to the access zone for the user, by decrementing an account specific to the user.

2. The method according to claim 1, wherein the method comprises, between the pre-validation step and the determination step, a step of sending a proof of pre-validation to the connected device,
during the determination step, the location of the connected device being determined from at least one location signal comprising the proof of pre-validation, the at least one location signal being received from the electronic device.

3. The method according to claim 1, wherein, during the receiving step, the request for access is received in an extended wireless communication mode.

4. The method according to claim 1, wherein in the pre-validation step a proof of pre-validation is generated in response to a comparison of the request for access to a database of rights to travel.

5. The method according to claim 1, further comprising an initialization step during which an initialization signal for the procedure is issued towards to the connected device in the approval zone according to a reception wireless communication mode, the determination step being performed on the basis of at least one signal exchanged according to a wireless location communication mode,
the reception and location wireless communication modes being distinct.

6. The method according to claim 5, wherein the reception and location wireless communication modes each follow a LAN protocol.

7. An electronic validation system of an access, for a user, to an access zone, to a public transport vehicle, the electronic validation system comprising:
a remote server comprising a set of module(s) configured for receiving a request for access to the access zone from the connected device in an approval zone, and for pre-validating the request for access if the request satisfies a predetermined condition,
at least one location transceiver for receiving a location signal from the connected device in the access zone separate from the approval zone, and
a local server connected to the at least one location transceiver and to the remote server, the local server comprising a calculation module apt to determine a location of the connected device,
wherein the set of module(s) is also configured, once the location of the connected device is determined to be in the access zone and only if the request for access is pre-validated, for validating an access to the access zone by the user, by decrementing an account specific to the user.

8. The system according to claim 7, wherein the access zone is located inside the public transport vehicle.

9. The system according to claim 7, wherein the access zone is located between at least one security gate and the public transport vehicle.

10. The system according to claim 9, wherein the calculation module is further configured for issuing an opening instruction of the or of one of the security gates following the determination of the location of the connected device in a entry zone and only if the request for access to the access zone has been pre-validated.
